(19) United States
(12) Patent Application Publication
(10) Pub. No.: US 2020/0034380 A1
(43) Pub. Date: Jan. 30, 2020

(54) SYSTEM FOR CLEARING MULTIPLE TRADEMARKS

(71) Applicant: Bradley J. Walz, Eagan, MN (US)

(72) Inventor: Bradley J. Walz, Eagan, MN (US)

(21) Appl. No.: 16/452,043

(22) Filed: Jun. 25, 2019

Related U.S. Application Data
(60) Provisional application No. 62/703,606, filed on Jul. 26, 2018.

(51) Int. Cl. G06F 16/33

(52) U.S. Cl. CPC G06F 16/3349; G06Q 50/18

(57) ABSTRACT

A computer-implemented system for performing trademark and service mark searches and automatically reporting the results thereof includes a first database containing information pertaining and registered trademarks and service marks and a second database containing related-goods data. The system further includes a computer program including instructions executable by a digital processing device, which include a first software module enabling a user to input values of search parameters including one or more proposed trademarks or service marks, and at least one corresponding goods or services description for each proposed mark, into a first spreadsheet. The program further includes a second software module configured to, for each of the one or more proposed marks, search the first and second databases and write the results and a corresponding determined score to a second spreadsheet, and a third software module configured to generate and send an electronic message containing the second spreadsheet to the user.

### CROSS REFERENCE TO RELATED APPLICATIONS

This application claims the benefit of U.S. Provisional Application Ser. No. 62/703,606, filed Jul. 26, 2018 and entitled SYSTEM FOR CLEARING MULTIPLE TRADEMARKS, the contents of which are hereby incorporated by reference in its entirety.

### SUMMARY

Conducting a manual trademark search for projects involving 20 or more trademarks or service marks is time consuming, cost prohibitive, and error prone. Using a computer-implemented system to perform a mulitname search project solves these problems. The invention is a computer-implemented system including databases and a software application that allows a user to complete an Excel worksheet with a minimum of one trademark or service or any number of trademark or service marks to be searched. Once completed, the user uploads the Excel worksheet to the software and then selects a minimum of one goods or services descriptions from a drop-down menu or any number of available goods or services descriptions. After the desired number goods or services descriptions is selected, the user enters an email address where the trademark search results are to be delivered and clicks “import.” The computer-implemented system then conducts searches of the databases based on the trademarks and/or service marks to be searched and the selected goods or services descriptions, and generates an email to the user including a completed Excel worksheet containing the trademark search results. The system sends this email to the user at the email address provided by the user.

### BACKGROUND OF THE INVENTION

Searching a trademark or service mark using the United States Patent and Trademark Office Electronic Search System (“TESS”) requires the searcher to input, at a minimum, the proposed trademark or service mark. TESS then returns a list of trademarks and service marks displaying in the user interface only the: (1) Application Serial No; (2) Registration Number (if any); (3) Word Mark; (4) Link to the Trademark Status and Document Retrieval page; and (5) LIVE/DEAD indication for each returned mark. The searcher needs to click on every similar Word Mark to see the detail for that particular trademark or service mark such as the description of the goods and services and the owner information.

The searcher must also determine whether the goods or services identified by the relevant trademarks and service marks in the list are related to the goods or services associated with the proposed mark. One way the searcher can assess the relatedness of goods or services is to consult a secondary source that contains prior decisions from the Trademark Trial and Appeal Board and United States District Courts that found certain goods or services to be related.

After clicking on each relevant mark in the list and consulting a secondary source, the searcher then needs to build a spreadsheet, chart, or list of the trademarks or service marks that support the conclusion about the availability of a proposed trademark or service mark. The time needed to conduct the initial search, click on the relevant marks, assess the relatedness of goods or services can take a searcher about 10 minutes per mark to complete. To build a spreadsheet, chart, or list of the trademarks or service marks relevant to the trademark searcher's search takes even more time.

A common practice amongst naming firms is to start each naming project with about 1,000 name candidates. The namer will narrow this list to 20 to 100 potential names. The namer will then conduct the trademark or service mark searches, or will hire someone to conduct the searches, for all potential names. The goal is to winnow the list down to a small list of potential names that could survive legal scrutiny from a search conducted by an experienced trademark attorney, and then present this list to the naming firm's client.

Trademark lawyers charge anywhere from $100 per name or more to conduct a preliminary trademark search. At these prices, it is cost prohibitive for naming firms to use a trademark lawyer to conduct multiple trademark searches. Moreover, it is time consuming for a trademark lawyer to conduct large numbers of trademark searches. At about 10 minutes per name, it would take a trademark lawyer over two full business days to conduct 100 trademark searches and report the search results to the namer. Additionally, if these searches are done consecutively to meet a deadline imposed by the naming firm, then the potential for errors increases.

### BRIEF DESCRIPTION OF THE DRAWINGS

FIG. 1 is a flow diagram illustrating an example method of using a system for searching and clearing multiple trademarks as described herein.

### DESCRIPTION OF THE INVENTION

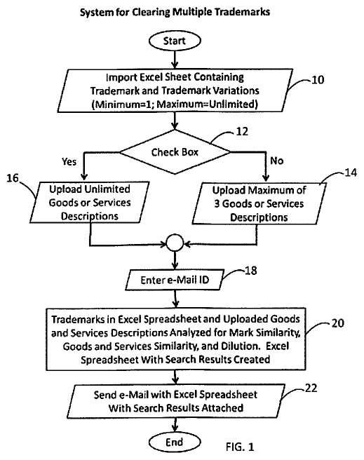

Using a computer-implemented system including databases and a software application to conduct multiple trademark searches is cost effective, time efficient, and reduces the potential for errors. The invention allows a user to complete an Excel spreadsheet template downloaded from the Internet, as shown in Box titled “10” of FIG. 1. As shown below as Table 1:

The Excel worksheet includes columns for the mark or marks being searched, a column for identifying the components of the searched mark (if any), a column for identifying the long form of the mark if the searched marked is an acronym, nickname, or abbreviation, and a column where truncation symbols and logical operators may be used. Column A must be completed by the user. Columns B, C, and D are optional. If Columns B and C contain text, then Column D cannot contain any text. If Column D contains text, than Columns B and C cannot contain text. After the user completes the Excel worksheet, it is saved to the user's computer and uploaded to the website where the multiname search is being conducted.

Next, the user must select one goods or services description from a drop down menu, but may select any number of goods or services descriptions that are available in the database, as shown in Boxes titled “12, 14, and 16” of FIG. 1. Finally, the user inputs an e-mail address and clicks “import” as shown in Box titled “18” of FIG. 1. The information entered by the user is uploaded to a server.

The software relies on two databases. One database contains information about pending trademark and service mark applications and registered trademarks and service marks. This information is downloaded daily from the United States Patent and Trademark Office (the “USPTO Data”). The second database contains goods and services descriptions that the Trademark Trial and Appeal Board have found are related (“Related Goods Data”). The software conducts five separate searches of the USPTO Data using information uploaded by the user and the Related Goods Data, as shown in Box titled “20” of FIG. 1:

First Search=the mark identified in Column A and the first goods or services description selected by the user.

Second Search=the mark identified in Column A and the first goods or services description from the Related Goods Data corresponding to the goods or services description selected by the user.

Third Search=the text identified in Columns B or C, or the text identified in Column D and the first goods or services description selected by the user.

Fourth Search=the text identified in Columns B or C, or the text identified in Column D and the first goods or services description from the Related Goods Data corresponding to the goods or services description selected by the user.

Fifth Search=the mark identified in Column A or the text identified in Column D and the United States Class Number associated with the first goods or services description selected by the user.

Each search is scored and the results are written to a blank Excel worksheet, as shown in Box titled “Trademarks in Excel Spreadsheet and Uploaded Goods and Services Descriptions Analyzed for Mark Similarity, Goods and Services Similarity, and Dilution. Excel Spreadsheet with Search Results Created” of FIG. 1. If the First, Second, Third, or Fourth Search returns three or fewer marks owned by different parties, the results are colored red. If the First, Second, Third, or Fourth search returns four or more marks owned by different parties, the results are colored yellow. If the Fifth Search returns three or fewer marks owned by different parties, the results are colored red. If the Fifth Search returns four or more marks owned by different parties, the results are colored blue. If a search returns no results, the message “no results found” is written to the Excel worksheet and colored green.

Except in the case of the Second and Third Searches, the software moves on to the next search only if no results are found during the current search. If results are found in the Second and Third Searches, the software will record first in the Excel worksheet the results colored red from either search. If the results from either search are yellow, the software will write the results from the Second Search to the Excel worksheet.

This search process is repeated for each goods or services description selected by the user. After all the searches are complete and the results have been written to the blank Excel worksheet, the software generates an email to the user and attaches the complete Excel worksheet containing the trademark search results. This email is sent to the user at the email address provided by the user, as shown in Box titled “22” of FIG. 1.

The description of the invention and is as set forth herein is illustrative and is not intended to limit the scope of the invention. Features of various embodiments may be combined with other embodiments within the contemplation of this invention. Variations and modifications of the embodiments disclosed herein are possible and practical alternatives to and equivalents of the various elements of the embodiments would be understood to those of ordinary skill in the art upon study of this patent document. These and other variations and modifications of the embodiments disclosed herein may be made without departing from the scope and spirit of the invention

What is claimed is:

1. A computer-implemented system for performing trademark and service mark searches and automatically reporting the results thereof, the system comprising:
a first database containing information pertaining to pending trademark and service mark applications, and registered trademarks and service marks;
a second database containing related-goods data; and
a computer program including instructions executable by a digital processing device, the program comprising:
a first software module that enables a user to enter values of a plurality of search parameters for one or more trademark or service mark searches into a first spreadsheet, the plurality of search parameters comprising:
one or more proposed trademarks or service marks; and
for each of the one or more proposed trademarks or service marks, at least one corresponding goods or services description;
a second software module configured to, for each of the one or more proposed trademarks or service marks:
search the first database for the proposed trademark or service mark;
search the second base for the at least one corresponding goods or services description;
determine a score based on the results of the searches of the first and second databases; and
write the results of the searches of the first and second databases and the corresponding score to a second spreadsheet;
a third software module configured to, after the second software module has written the results of the searches of the first and second databases and the corresponding score to a second spreadsheet for each of the one or more proposed trademarks or service marks:
generate an electronic message to the user;
attach the second spreadsheet to the electronic message; and
send the electronic message to the user via the Internet.

2. The computer-implemented system of claim 1, wherein the plurality of search parameters further comprises, for at least one of the one or more proposed trademarks or service marks, one or more components of the proposed trademark.

3. The computer-implemented system of claim 1, wherein at least one of the one or more proposed trademarks or service marks is an acronym, nickname, or abbreviation, and wherein the plurality of search parameters further comprises a long form of the at least one of the one or more proposed trademarks or service marks.

4. The computer-implemented system of claim 1, wherein the plurality of search parameters further comprises, for at least one of the one or more proposed trademarks or service marks, one or more corresponding truncated symbols or logical operators.

5. The computer-implemented system of claim 1, wherein the score comprises at least one of a color or a number corresponding to a number of owned trademarks or service marks returned by the searches of the first and second databases.
